(19) United States
(12) Patent Application Publication
(10) Pub. No.: US 2009/0254824 A1
(43) Pub. Date: Oct. 8, 2009

(54) Distribution Of Context Aware Content And Interactable Advertisements

(76) Inventor: Gurvinder Singh, San Francisco, CA (US)

Correspondence Address: Ashok Tankha, 36 Greenlelgh Drive, Sewell, NJ, 08080, US

(21) Appl. No.: 12/099,169

(22) Filed: Apr. 8, 2008

(51) Int. Cl. G06F 3/048; G06Q 30/00; G01C 21/00

(52) U.S. Cl. 715/716; 705/14; 701/213; 705/10

(57) ABSTRACT

Disclosed herein is a method and system for providing context aware multimedia content and interactable advertisements of business services on visually distinct and mutually independent display sections on a mobile device screen of a user. A client application is provided on the mobile device. The client application sends a first request for multimedia content to a content server and a second request for the interactable advertisements to an advertisement server. The content server establishes context of the first request, selects the multimedia content based on established context, and renders the multimedia content on a first display section on the mobile device screen. The advertisement server establishes context of the second request, selects the interactable advertisements based on established context, and renders the interactable advertisements on a second display section on the mobile device screen. The user accesses the business services through the interactable advertisements using the client application.

### CROSS REFERENCE TO RELATED APPLICATIONS

The following patents are incorporated herein as references:
1. This application claims the benefit of provisional patent application number U.S. “60/910,486” titled “Context-Aware, Non-Content Embedded Advertisement And Content Distribution Application Framework For Mobile Devices”, filed on Apr. 6, 2007 at the United States Patent And Trademark Office.
2. PCT patent application number PCT/US08/59327 titled “Distribution Of Context Aware Content And Interactable Advertisements”, filed on Apr. 4, 2008 through the United States Patent And Trademark Office.

### BACKGROUND

This invention, in general, relates to wireless technology. More particularly, this invention relates to a method of providing context aware multimedia content and interactable advertisements of business services on visually distinct and mutually independent display sections on a mobile device screen of a user.

Typically, mobile advertising and multimedia content distribution involves sending advertisements, short message service advertisements, local information updates, service provider calls, etc. to the mobile device of the user. The advertisements and the multimedia content delivered may be not be relevant to the user of the mobile device and may go unnoticed. The advertisements delivered on the mobile device may also be intrusive to the user of the mobile device causing inconvenience to the user. The user may like to obtain information and advertisements related to the various events, commercial enterprises, retail stores, and businesses of interest to the user.

The user may also need help in finding the location and directions to the events and the commercial enterprises. The user may also need updates on availability of service providers in the vicinity of the user. The user may also need the addresses and contact information of service providers to locate the business services of the service providers or place an order with the business services. Therefore, there is a need for providing the user with direct access to the business services of the service providers.

Moreover, service providers generally send advertisements embedded with multimedia content. The advertisements embedded with multimedia content may be intrusive to the user. Therefore, there is a need for providing non content embedded advertisements on the mobile device screen of the user. The service providers would therefore need to advertise their products and services in a non intrusive manner and cater to the preferences of the user of the mobile device.

The service providers may also want to target customers by providing location based advertisements, time based advertisements, and weather based advertisements to the mobile device of the user. For example, the service providers may want to target customers at the closest location of their chain store, send a lunch menu or a dinner menu based on time of day, and a cold drink in hot weather. Therefore, there is a need for service providers to render context-aware multimedia content and advertisements to the mobile device of the user.

Hence, there is an unmet need for a method and system that provides a user with non intrusive context aware multimedia content and the interactable advertisements on the visually distinct and mutually independent display sections on the mobile device screen of the user.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The method and system disclosed herein addresses the above stated needs for providing a user with non intrusive context aware multimedia content and interactable advertisements of business services on visually distinct and mutually independent display sections on a mobile device screen of a user. Providers of the business services are herein referred to as “service providers”.

The method and system disclosed herein provides a client application to the user of the mobile device. The user and the service providers may register on a host website and provide user information and service provider information. The user information may include content preferences of the user, user profile, and software and hardware capabilities of the mobile device used by the user. The service provider information may include advertisements, advertising preferences associated with dynamic user interface components to be displayed on the client application, contact information, promotional coupons, sales coupons, relevant multimedia content downloads and driving directions to locations of the service providers. The advertisements provided by the service providers may comprise advertisement banner images, coupon images, promotional audio downloads, promotional video downloads, phone numbers of the business services, addresses of the business services, and business service delivery constraints.

The client application sends a first request for the context aware multimedia content to a content server and a second request for the context aware interactable advertisements to an advertisement server. The first request and the second request may be sent synchronously or asynchronously.

The content server establishes the context of the first request and the advertisement server establishes the context of the second request based on contextual parameters. The contextual parameters may comprise location of the mobile device, date, time in the location, weather at the location, events at the location, and traffic at the location. The location of the mobile device is determined based on global positioning system capabilities of the mobile device. The contextual parameters may also comprise the multimedia content and the interactable advertisements previously rendered on the mobile device, user profile, preferences of the user, and request patterns of the user. The contextual parameters may further comprise usage of the multimedia content and the interactable advertisements by the user over a predefined period of time and the software and hardware capabilities of the mobile device.

On establishing the context of the first request, the content server selects the multimedia content to be rendered to the client application. On establishing the context of the second request, the advertisement server selects the interactable advertisements of the business services to be rendered to the client application. The interactable advertisements comprise dynamic user interface components for enabling the user to activate one or more access functions on the client application to access the business services.

The content server then renders the selected multimedia content on a first display section on the mobile device screen of the user. The advertisement server renders the selected interactable advertisements on a second display section on the mobile device screen of the user. The dynamic user interface components of the rendered interactable advertisements may be displayed on a third display section on the mobile device screen of the user. The display positioning and scaling of the visually distinct and mutually independent display sections on the client application may be dynamically manipulated by the client application.

The content server renders the multimedia content independent of the rendering of the interactable advertisements by the advertisement server. The independent rendering of the multimedia content and the interactable advertisements by the content server and the advertisement server respectively may be based on predefined criteria. The predefined criteria may comprise time of expiry allotted for display of the multimedia content and the interactable advertisements, activities performed by the user on the client application, change in location of the mobile device, or change in the schedule of events at the location of the user. The content server and the advertisement server may render the multimedia content and the interactable advertisements respectively at different intervals of time. For example, if the time of expiry allotted for the display of the multimedia content is different from the time of expiry allotted for the display of the interactable advertisements, then the multimedia content and the interactable advertisements may be rendered at different time intervals on the client application.

The user accesses the interactable advertisements of the business services on the mobile device of the user through the client application. The user activates a plurality of access functions by utilizing the dynamic user interface components of the interactable advertisements such as a clickable advertising banner, a “Click To Call” button, a “Click To Map” button, etc. The dynamic user interface components may enable the user to make phone calls to the business services and send voice messages or text messages to the business services. The dynamic user interface components may also enable the user to obtain directions to locations of the business services, obtain promotional coupons and sales coupons of the business services. The dynamic user interface components may also enable the user to download the multimedia content from business service websites and access websites of the business services. Further, one or more dynamic user interface components may enable the user to navigate through a list of the access functions displayed as an advertisement menu on the client application.

The non intrusive context aware multimedia content and the interactable advertisements relevant to the user may be delivered to the mobile device of the user to address specific requirements of the user. The rendered interactable advertisements may allow the user to respond to the advertisements without necessity of exiting the mobile device environment. The location specific advertisements may allow the service providers to target the users positioned in the vicinity of the business services. The content server and the advertisement server may utilize mobile applications developed from third party service providers to provide the multimedia content such as news, stock quotes, jokes, etc. to the user.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a method of providing context aware multimedia content and interactable advertisements of business services on visually distinct and mutually independent display sections on a mobile device screen of a user.

FIG. 2 illustrates a system for providing context aware multimedia content and interactable advertisements of business services on visually distinct and mutually independent display sections on a mobile device screen of a user.

FIG. 3A-3B exemplarily illustrates a graphical user interface of a client application on a mobile device screen of a user.

FIG. 4 exemplarily illustrates an advertising portal on a host website for service providers.

FIG. 5 exemplarily illustrates the processes involved in providing context aware multimedia content on visually distinct and mutually independent display sections on a mobile device screen of a user.

FIG. 6 exemplarily illustrates the processes involved in providing context aware interactable advertisements of business services on visually distinct and mutually independent display sections on a mobile device screen of a user.

### DETAILED DESCRIPTION OF THE INVENTION

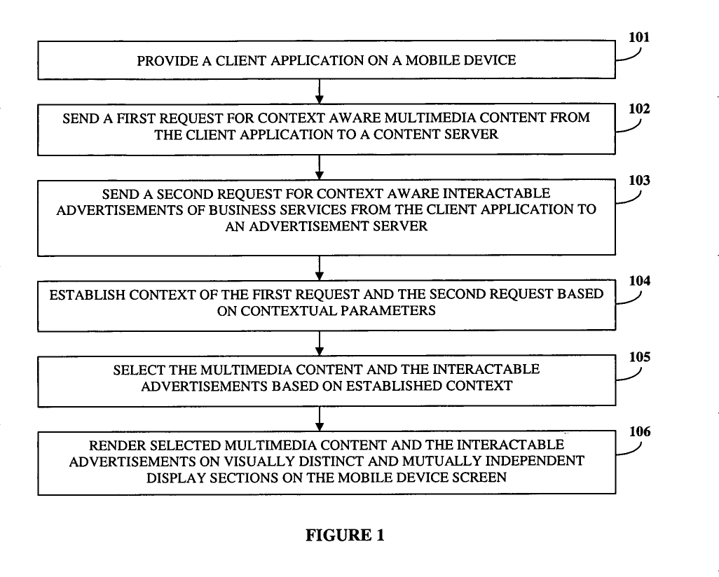

FIG. 1 illustrates a method of providing context aware multimedia content and interactable advertisements of business services on visually distinct and mutually independent display sections on a mobile device screen of a user 201. The multimedia content may be audio content, image content, video content, or text content such as news, jokes, music, trivia and stock quotes. The mobile device 202 may be one of a mobile phone, a feature phone, smart phone, a personal digital assistant, a laptop, a palmtop, and any handheld computing device. The mobile device 202 may have global positioning system (GPS) capabilities to provide location coordinates of the mobile device 202. Providers of products and services herein referred to as “service providers” provide business services to the user 201 through interactable advertisements on the mobile device 202. The interactable advertisements comprise dynamic user interface components 301 for the user 201 to access the business services.

The user 201 may register on a host website and provide user information comprising content preferences of the user 201, user profile and software and hardware capabilities of the mobile device 202 of the user 201. The user profile may comprise name, age, sex, occupation, and electronic mail (email) address of the user 201. The service providers 203 of the business services may also register on the host website and provide service provider information. The service provider information may comprise advertisements, advertising products purchased based on advertising options selected, advertising preferences associated with the dynamic user interface components 301 to be displayed on the client application 202a, contact information, promotional coupons and sales coupons, multimedia content downloads, and driving directions to locations of the business services of the service providers 203.

The advertisements provided by the service providers 203 may comprise advertisement banner images, coupon images, promotional audio downloads, promotional video downloads, phone numbers of the business services, addresses of the business services, and business service delivery constraints. The business service delivery constraints may include restrictions for an advertisement to be shown at an instant of time. For example, an advertisement may be shown during certain hours of the day or on certain days of the week. The directions to the locations of the business services may be displayed on the client application 202a as a text based direction, a static map or a GPS direction map. The host website may manipulate the service provider information based on the software and hardware capabilities of the mobile device 202. For example, images of the advertisements provided by the service providers 203 may be duplicated and scaled to conform to the software capabilities and hardware capabilities of the mobile device 202.

The method disclosed herein provides 101 a client application 202a to the user 201 of the mobile device 202. The user 201 may also register on the host website through the client application 202a by sending a text message. The client application 202a enables the user 201 to receive context aware multimedia content and the interactable advertisements of the business services on the visually distinct and mutually independent display sections on the user's 201 mobile device screen. The user 201 activates the client application 202a on the mobile device 202. The client application 202a then sends 102 a first request for the context aware multimedia content to a content server 206. The client application 202a sends 103 a second request for the context aware interactable advertisements to an advertisement server 205. The first request and the second request may be sent synchronously or asynchronously by the client application 202a. The client application 202a may also send the first request and the second request based on change in location of the mobile device 202 or change in schedule of events at the location of the user 201.

On receiving the first request and the second request sent by the client application 202a, the content server 206 and the advertisement server 205 establish 104 context of the first request and the second request respectively. The context of the first request and the second request is established based on contextual parameters. The contextual parameters comprise location of the mobile device 202, date, time, weather, events at the location, and traffic at the location. The contextual parameters may also comprise preferences of the user 201, the user profile, request patterns of the user 201, content and advertisement usage by the user 201 over a predefined period of time, software and hardware capabilities of the mobile device 202, and any combination thereof. When the client application 202a sends the first request and the second request, the user profile and time of sending the first request and the second request are determined. The location of the mobile device 202 is then determined using GPS capabilities of the mobile device 202. Information regarding the weather, the events at the location, and the traffic at the location may then be determined based on the time of the requests and the location of the mobile device 202.

On establishing the context of the first request, the content server 206 selects 105 the multimedia content to be rendered to the client application 202a based on the established context. On establishing the context of the second request, the advertisement server 205 selects 105 the interactable advertisements to be rendered to the client application 202a based on the established context. The interactable advertisements are selected based on the advertising preferences selected by the service providers 203 and the advertisements provided by the service providers 203 during registration. For example, if the service providers 203 intend to provide the user 201 with the interactable advertisements for phone numbers of the business services and driving directions to the location of the business services, the service providers 203 may select an advertising preference associated with the dynamic user interface components 301 for displaying a “Click To Call” button 301b and a “Click To Map” button 301c respectively to the user 201. The dynamic user interface components 301 of the interactable advertisements selected by the service providers 203 in the advertising preferences will be displayed on a graphical user interface (GUI) 202b of the client application 202a.

Based on the established context, nature of the multimedia content and the interactable advertisements selected may depend on the weather at the location of the user 201. For example, if the information regarding the weather at the location of user 201 is established as hot and humid on receiving the first request and second request sent by the client application 202a, the advertisement server 205 may select advertisements for cold drinks and the content server 206 may select multimedia content with health tips for the hot season. The nature of the multimedia content and the interactable advertisements selected may also depend on the time at the instance of sending the first request and the second request. For example, the advertisement server 205 may select advertisements for lunch menus and the content server 206 may select multimedia content with health related information when the time at the instance of sending the first request and the second request is lunch time. The content server 206 and the advertisement server 205 may also select the multimedia content and the interactable advertisements respectively based on the established proximity of the business services to the location of the user 201. The change in the location of the mobile device 202 or the change in the schedule of the local events at the location may also influence the nature of the multimedia content and the interactable advertisements selected.

The content server 206 and the advertisement server 205 may also select the multimedia content and the interactable advertisements respectively, based on the established profile of the user 201. For example, the interactable advertisements and the multimedia content selected may cater to the user 201 belonging to an age group predefined by the service providers 203. The content server 206 and the advertisement server 205 may also select the multimedia content and the interactable advertisements based on the established long term usage pattern of the user 201. For example, if the user 201 responded to the interactable advertisements of a specific service provider consistently over a predefined period of time, then the interactable advertisements from the specific service provider may be selected. The advertisement server 205 may also select the interactable advertisements based on popularity of the service providers 203. For example, the advertisement server 205 may select the interactable advertisements generating wide response from users.

The content server 206 and the advertisement server 205 then render the selected multimedia content and the selected interactable advertisements respectively on visually distinct and mutually independent display sections on the mobile device screen. For example, the content server 206 renders 106 the selected multimedia content on a first display section herein referred to as “content window” on the user's 201 mobile device screen. The advertisement server 205 renders 106 the selected interactable advertisements on a second display section herein referred to as “advertisement window” on the user's 201 mobile device screen. The dynamic user interface components 301 of the rendered interactable advertisements may be displayed on a third display section on the user's 201 mobile device screen. The display positioning and scaling of the visually distinct and mutually independent display sections on the client application 202a may be dynamically manipulated by the client application 202a.

The rendering of the multimedia content by the content server 206 is independent of the rendering of the interactable advertisements by the advertisement server 205. The independent rendering of the multimedia content and the interactable advertisements by the content server 206 and the advertisement server 205 may be based on predefined criteria. The predefined criteria may comprise time of expiry allotted for display of the multimedia content and the interactable advertisements, activities performed by the user 201 on the client application 202a, change in location of the mobile device 202, or change in the schedule of events at the location of the user 201. The content server 206 and the advertisement server 205 may render the multimedia content and the interactable advertisements respectively by predefining the time of expiry allotted for the display of the rendered multimedia content and the rendered interactable advertisements.

The rendered multimedia content and the rendered interactable advertisements may be updated on the client application 202a when duration of display of the multimedia content and the interactable advertisements exceed the predefined time of expiry allotted for the display of the multimedia content and the interactable advertisements. For example, an interactable advertisement for a jewelry store may first be rendered. The rendered interactable advertisement for the jewelry store may then be updated automatically on the client application 202a with an interactable advertisement for a gas station when duration of the display of the interactable jewelry store advertisement exceeds the predefined time allotted for the display of the jewelry store advertisement. The multimedia content and the interactable advertisements may be updated at different intervals of time on the client application 202a. For example, if the predefined time of expiry allotted for the display of the multimedia content is different from the predefined time of expiry allotted for the display of the interactable advertisements, then the content server 206 and the advertisement server 205 may independently render the multimedia content and the interactable advertisements at the different time intervals on the client application 202a.

The user 201 accesses the business services through the rendered interactable advertisements displayed on the mobile device screen. The user 201 activates one or more access functions by utilizing the dynamic user interface components 301 of the interactable advertisements. The dynamic user interface components 301 such as a clickable advertising banner 301a, a “Click To Call” button 301b, a “Click To Map” button 301c, a “Click To Coupon” button, a “Click To Info” button, or a “Click To Mobile Landing Page” button may be provided to activate the access. The access functions may enable the user 201 to make phone calls to the business services, send voice messages or text messages to the business services, obtain directions to the locations of the business services, obtain promotional coupons and sales coupons of the business services, download the multimedia content from business service websites, and access websites of the business services. For example, by clicking on the clickable advertising banner 301a of a pizza store, the user 201 may view the interactable advertisements for a pizza store located in close proximity to the location of the user 201 on the client application 202a. The user 201 may then click on the “Click To Call” button 301b to call the pizza store to place an order.

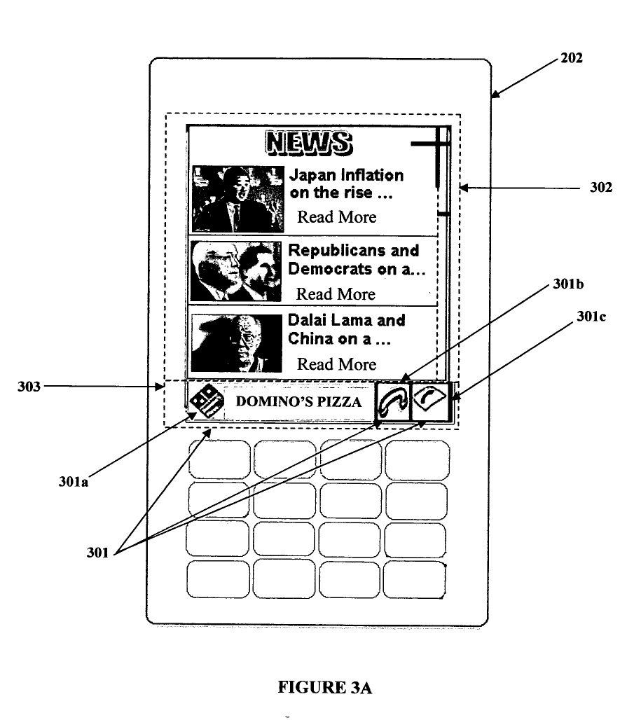

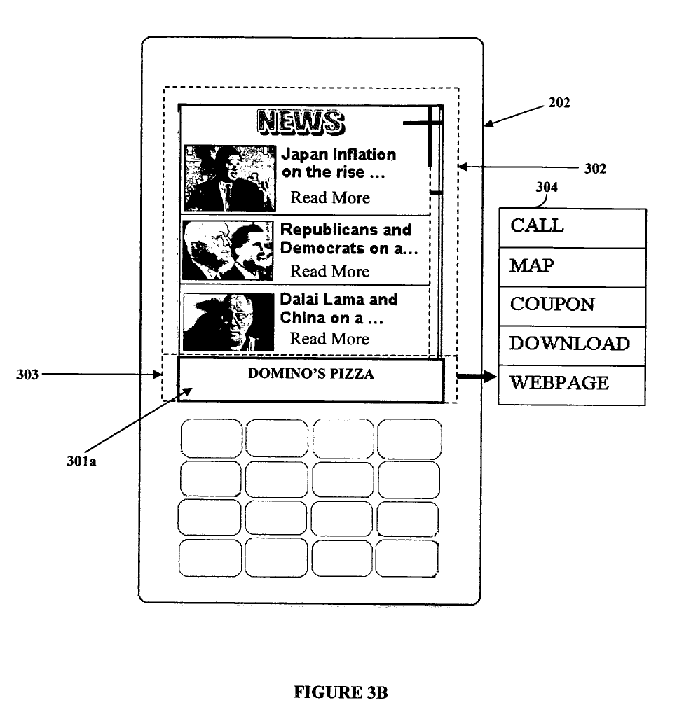

The user 201 may also obtain driving directions to the location of the pizza store or obtain the address of the pizza store by clicking the “Click To Map” button 301c on the GUI 202b of the client application 202a. The user 201 may also utilize the promotional and sales coupons offered by the pizza store by clicking on the “Click To Coupon” button. One or more dynamic user interface components 301 may enable the user 201 to navigate through a list 304 of the access functions displayed as an advertisement menu on the client application 202a. For example, the user 201 may click on a clickable advertisement banner 301a and an advertisement menu comprising a list 304 of access functions may be displayed on the client application 202a as illustrated in FIG. 3B. The user 201 may then utilize the advertisement menu to navigate through the list 304 of access functions. The list 304 of access functions may allow the user 201 to make a call, request for a map, request for a coupon, request to download a audio content, video content, image content, or text content, and to access a webpage of the host website.

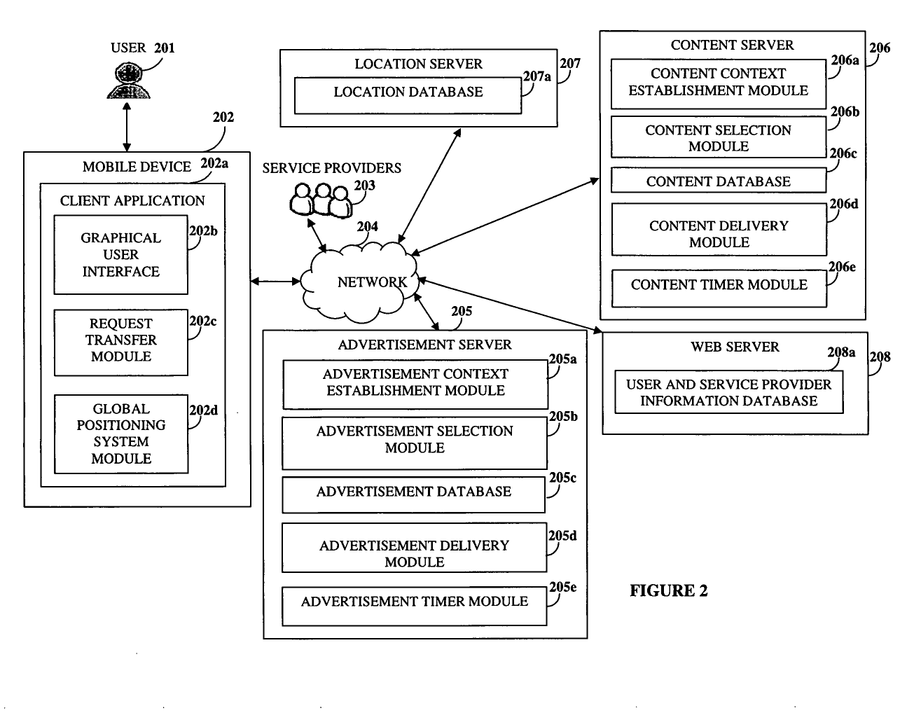

FIG. 2 illustrates a system for providing context aware multimedia content and interactable advertisements of business services on visually distinct and mutually independent display sections on a mobile device screen of a user 201. The multimedia content may comprise text content, image content, audio content, and video content such as news, movie trailers, pictures, jokes, trivia, astrology, and stock quotes. The interactable advertisements comprise the dynamic user interface components 301 for the user 201 to access the business services. The system disclosed herein comprises a client application 202a, a content server 206, an advertisement server 205, a location server 207, and a web server 208 connected via a network 204.

The web server 208 comprises a user and service provider information database 208a. The user 201 and service providers 203 of the business services may register on a host website implemented on the web server 208. The user 201 provides user information comprising content preferences of the user 201, user profile and software capabilities and hardware capabilities of the mobile device 202 of the user 201. The service providers 203 provide service provider information comprising advertisements, advertising products purchased based on advertising preferences associated with dynamic user interface components 301 selected to be displayed on the client application 202a, contact information, promotional coupons, sales coupons, and driving directions to locations of the business services of the service providers 203. The user and service provider information database 208a stores the user information provided by the user 201 and the service provider information provided by the service providers 203. The web server 208 may also access the user and service provider information database 208a remotely via the network 204.

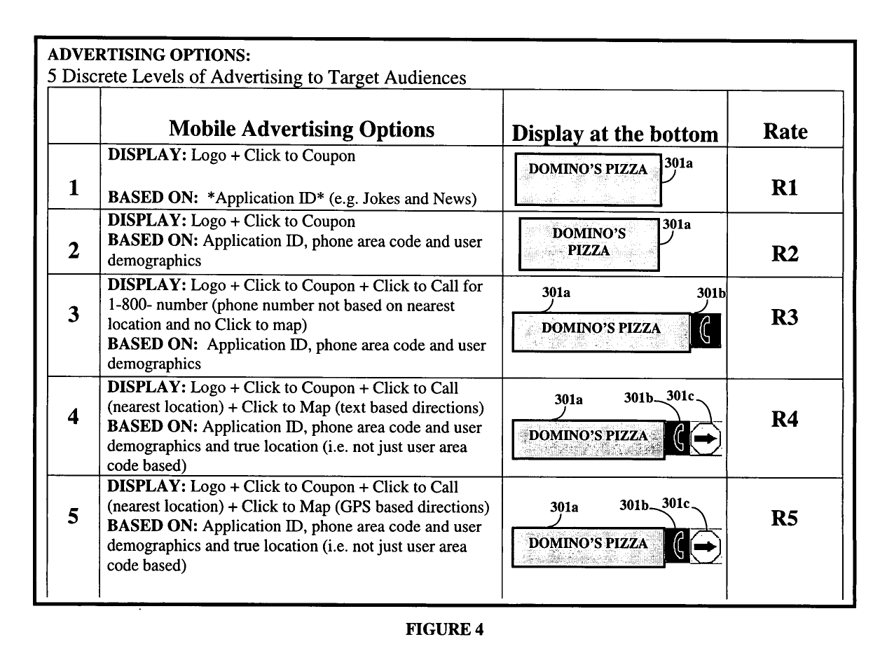

The service providers 203 may select the advertising preferences associated with the dynamic user interface components 301 of the interactable advertisements available on an advertising portal of the host website as illustrated in FIG. 4. Based on types of services the service providers 203 intend to provide to the user 201, the service providers 203 may select an advertising preference associated with the dynamic user interface components 301 that provide the intended type of service. For example, the service providers 203 may purchase one of the advertising preferences associated with the dynamic user interface components 301 for providing directions to the location of the business services. The service providers 203 may also purchase one of the advertising preferences associated with the dynamic user interface components 301 for providing both phone numbers and addresses of the business services.

The client application 202a comprises a graphical user interface (GUI) 202b, a request transfer module 202c, and a global positioning system (GPS) module 202d. The client application 202a is installed on the mobile device 202 of the user 201. The user 201 may download the client application 202a onto the mobile device 202 by sending a text message through the client application 202a to the host website hosted on the web server 208. The user 201 may also download the client application 202a onto the mobile device 202 from the host website via the network 204.

The GUI 202b of the client application 202a displays the context aware multimedia content and interactable advertisements on visually distinct and mutually independent display sections on the mobile device screen as illustrated in FIG. 3B. The visually distinct and mutually independent display sections on the client application 202a may comprise a content window 302 for displaying the context aware multimedia content, an advertisement window 303 for displaying the context aware interactable advertisements, and a third display section for displaying the dynamic user interface components 301 of the interactable advertisements. For example, the GUI 202b may comprise the content window 302 covering 70 per cent of the mobile device screen and the advertisement window 303 covering 30 per cent of the mobile device screen. The GUI 202b may also comprise a button window for displaying the dynamic use interface components 301.

The request transfer module 202c of the client application 202a sends a first request for one or more of the multimedia content to the content server 206. The request transfer module 202c sends a second request for one or more of the interactable advertisements to the advertisement server 205. The request transfer module 202c may send the first request and the second request synchronously or asynchronously.

The GPS module 202d of the client application 202a transfers the GPS coordinates of the mobile device 202 of the user 201 to the location server 207 along with the first request and the second request. The location server 207 performs reverse geocoding of the GPS coordinates transferred from the GPS module 202d to determine location of the mobile device 202. The location server 207 comprises a location database 207a. The location database 207a stores the location based information such as date, time, weather, events at the location, and traffic at the location. The location server 207 communicates with the location database 207a to determine the location based information. The location server 207 may also access the location database 207a remotely via the network 204. The location server 207 performs the functions of geocoding, reverse geocoding, routing, map rendering, and points of interest (POI) search. Digital maps may be provided to the location server 207 by third party service providers.

The content server 206 comprises a content context establishment module 206a, a content selection module 206b, a content database 206c, a content delivery module 206d, and a content timer module 206e. The content context establishment module 206a establishes context of the first request sent by the request transfer module 202c based on contextual parameters. The content context establishment module 206a determines the location of the mobile device 202, date, time, weather, events at the location, traffic at the location, multimedia content previously rendered to the mobile device 202, user profile, preferences of the user 201, request patterns of the user 201, content and advertisement usage by the user 201 over a predefined period of time, and software and hardware capabilities of the mobile device 202. The content context establishment module 206a interacts with the location server 207 to determine the location of the mobile device 202 of the user 201. The content context establishment module 206a also interacts with the user and service provider information database 208a to determine the user profile and the user information. The content context establishment module 206a may access the user and service provider information database 208a remotely via the network 204.

The content selection module 206b selects the multimedia content from the content database 206c based on the established context. The content server 206 may access the content database 206c remotely via the network 204. The content database 206c of the content server 206 stores the multimedia content. The multimedia content may comprise text content, audio content, and video content. The multimedia content may be mobile applications providing services such as stock quotes, news, jokes, astrology, etc. The multimedia content may be created by client application provider or obtained from third party service providers.

The advertisement server 205 comprises an advertisement context establishment module 205a, an advertisement selection module 205b, an advertisement database 205c, an advertisement delivery module 205d, and an advertisement timer module 205e. The advertisement context establishment module 205a establishes context of the second request sent by the request transfer module 202c based on the contextual parameters. The advertisement context establishment module 205a interacts with the location server 207 to determine the location of the mobile device 202 of the user 201. The advertisement context establishment module 205a also interacts with the user and service provider information database 208a to determine the user profile and the user information.

The advertisement selection module 205b selects the interactable advertisements from the advertisement database 205c based on the established context of the second request. The advertisement database 205c stores the interactable advertisements and accounting information associated with the advertisement campaigns. The accounting information comprises the advertisements, products based on the advertising preferences selected by the service providers 203, number of impressions paid for, click through statistics, etc. The advertisement selection module 205b selects the interactable advertisements based on the advertising preferences selected by the service providers 203 and the advertisements provided by the service providers 203. The advertisement server 205 may access the advertisement database 205c remotely via the network 204.

The content selection module 206b and the advertisement selection module 205b may interact with the location server 207 to select the multimedia content and the interactable advertisements respectively based on the established location based information of the user 201. The advertisement server 205 also utilizes the location server 207 for accessing additional location based services such as POI search, map rendering, obtaining location attributes, embedding the location information into client application generated data such as geotagging pictures and videos with location of content creation. Further, the content server 206 utilizes the location server 207 to customize the selected multimedia content based on the location. For example, the content server 206 may provide news at the location of the user 201 based on the established location based information obtained by reverse geocoding the GPS coordinates transferred by the client application 202a. The content server 206 may also provide regional jokes and sports trivia focusing on statistics for local teams. The content server 206 may further serve all the local radio stations based on the GPS coordinates as a default on the mobile device 202.

The content delivery module 206d renders the multimedia content selected by the content selection module 206b on the content window 302 of the GUI 202b of the client application 202a. The advertisement delivery module 205d renders the interactable advertisements selected by the advertisement selection module 205b on the advertisement window 303 of the GUI 202b of the client application 202a. The content window 302 and the advertisement window 303 are visually distinct and mutually independent display sections on the mobile device screen.

The rendered multimedia content and the rendered interactable advertisements may be updated automatically on the client application 202a by predefining the time allotted for the display of the rendered multimedia content and the rendered interactable advertisements. The content timer module 206e determines the duration of display for the rendered multimedia content on the GUI 202b. The advertisement timer module 205e determines the duration of display for the rendered interactable advertisements on the GUI 202b. For example, when the duration of display of the rendered multimedia content determined by the content timer module 206e exceeds the predefined time allotted for the display, the rendered multimedia content is updated on the content window 302 of the mobile device screen. Similarly, when the duration of display of the rendered interactable advertisements determined by the advertisement timer module 205e exceeds the predefined time allotted for the display, the rendered interactable advertisements are updated on the advertisement window 303 of the mobile device screen.

The GUI 202b provides access to the rendered interactable advertisements of the business services. The dynamic user interface components 301 enable the user 201 to activate one or more access functions through the GUI 202b. The access functions comprise calling the business services, sending voice messages or text messages to the business services, obtaining directions to locations of the business services, obtaining promotional coupons and sales coupons of the business services, and accessing websites of the business services. The directions to the locations of the business services are displayed on the client application 202a as one of a text based direction, a static map, and a GPS direction map.

The dynamic user interface components 301 may comprise an advertisement banner image, a clickable advertising banner 301a, and a set of functional buttons 301b and 301c as illustrated in FIG. 3A. On click of the clickable advertising banner 301a, the user 201 may access and retrieve location dependent multimedia content. For example, a local coupon with a scannable barcode from the content server 206 may be provided when the user 201 clicks the clickable advertising banner 301a. The set of functional buttons may comprise a “Click To Call” button 301b to enable the user 201 to call the service providers 203. The set of functional buttons may also comprise a “Click To Map” button 301c to enable the user 201 to obtain a map, addresses, or directions to locations of the business services of the service providers 203. The set of functional buttons may also comprise a “Click To Download” button to download multimedia content such as the movie trailers, the pictures.

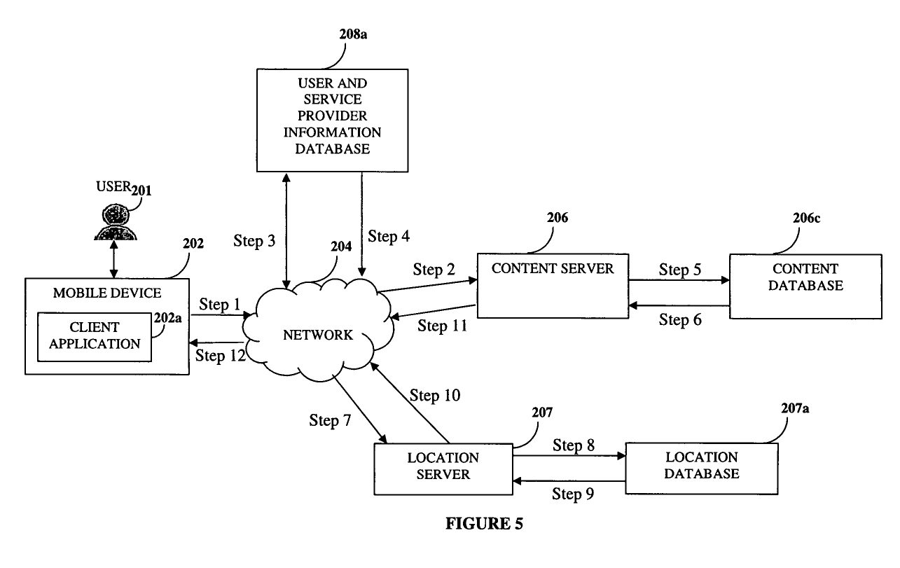

FIG. 5 exemplarily illustrates a process of providing context aware multimedia content on one of the visually distinct and mutually independent display sections on a mobile device screen of a user 201. The user 201 runs the client application 202a. In “Step 1”, the client application 202a sends a request for the multimedia content. In “Step 2”, the request is directed to a content server 206. In “Step 3”, the content server 206 remotely accesses the user and service provider information database 208a to obtain information such as such as a mobile application identifier, a user identifier, and software and hardware capabilities of the mobile device 202 of the user 201 contained in the sent request. In “Step 4”, information from the user and service provider information database 208a is sent back to the content server 206.

In “Step 5”, the content server 206 remotely accesses the content database 206c for the multimedia content. In “Step 6”, a set of the multimedia content may be selected from the content database 206c and delivered to the content server 206 based on the information contained in the sent request. In “Step 7”, the content server 206 may utilize the location server 207 to perform reverse geocoding of the GPS coordinates transferred from the client application 202a to determine location of the mobile device 202. In “Step 8”, the location server 207 sends the reverse geocoded information to the location database 207a. In “Step 9”, the location server 207 obtains location based information from the location database 207a. In “Step 10”, the content server 206 may then utilize the location based information to select the type of the multimedia content within the selected multimedia content to be delivered to the user 201. For example, when the user 201 requests for news, the content server 206 may first obtain the multimedia content related to news from the content database 206c. The content server 206 may then utilize the location server 207 to obtain location based information and select the news specific to the location of the user 201 determined by the location server 207. In “Step 11” and “Step 12”, the content server 206 delivers the selected multimedia content to the client application 202a on the content window 302 on the mobile device screen of the user 201 via the network 204.

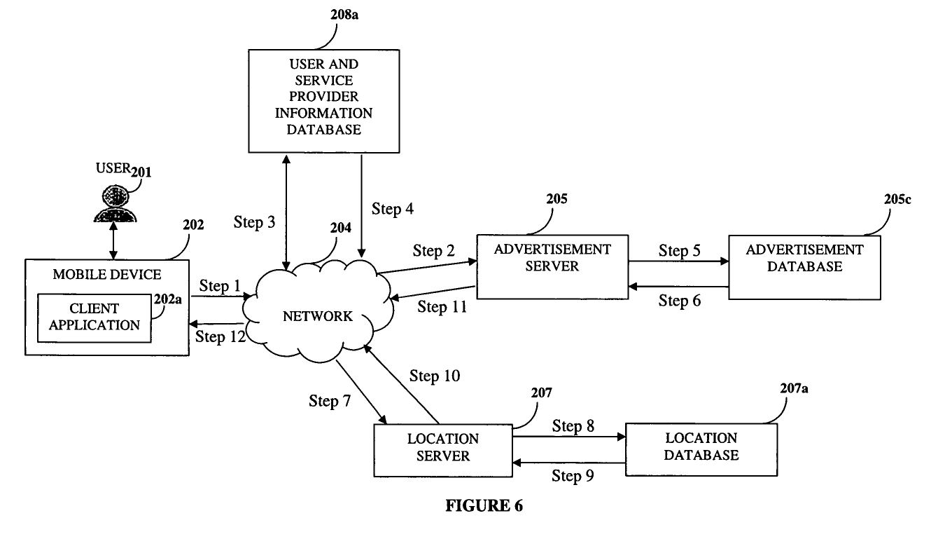

FIG. 6 exemplarily illustrates a process of providing context aware interactable advertisements of business services on one of the visually distinct and mutually independent display sections on a mobile device screen of a user 201. The user 201 runs the client application 202a. In “Step 1”, the client application 202a sends a request for the interactable advertisements. In “Step 2”, the request is directed to an advertisement server 205. In “Step 3”, the advertisement server 205 remotely accesses the user and service provider information database 208a to obtain information such as such as a mobile application identifier, a user identifier, and software and hardware capabilities of the mobile device 202 of the user 201 contained in the sent request. In “Step 4”, information from the user and service provider information database 208a is sent back to advertisement server 205.

In “Step 5”, the advertisement server 205 remotely accesses the advertisement database 205c for advertisement campaigns. In “Step 6”, a set of the advertisement campaigns may be selected from the advertisement database 205c and delivered to the advertisement server 205 based on the information contained in the sent request. The set of advertisement campaigns delivered may have accounting information such as advertising preferences selected by the service providers 203, number of impressions associated with the service providers 203, and the number of times the user 201 has received the advertisement campaigns in the past.

The advertisement server 205 may then select an advertisement campaign from the set of advertisement campaigns received from the advertisement database 205c based on the accounting information associated with the advertisement campaigns. For example, the advertisement server 205 may select an advertisement campaign from a service provider based on the number of impressions associated with the service provider. The selected advertisement campaign may also have a constraint that restricts the number of times the selected advertising campaign is delivered to the mobile device 202 of the user 201. The constraint may provide opportunities for advertisement campaigns from other service providers 203 to be delivered to the user 201.

In “Step 7”, the advertisement server 205 may utilize the location server 207 to perform reverse geocoding of the GPS coordinates transferred from the client application 202a to determine location of the mobile device 202. In “Step 8”, the location server 207 sends the reverse geocoded information to the location database 207a. In “Step 9”, the location server 207 obtains location based information from the location database 207a. In “Step 10”, the advertisement server 205 may then utilize the location based information to select the type of advertisement within the selected advertisement campaign to be delivered to the user 201. For example, a coffee shop may be running an advertisement campaign with two advertisements. The first advertisement may be for a hot drink and the second advertisement for a cold drink. The advertisement server 205 may then obtain weather information at the location of the mobile device 202 of the user 201 from the location database 207a. The advertisement server 205 may then select the appropriate advertisement within the advertisement campaign from the advertisement database 205c based on the weather. In “Step 11” and “Step 12”, the advertisement server 205 delivers the advertisement to the client application 202a on the advertisement window 303 on the mobile device screen of the user 201 via the network 204. The advertisement server 205 may manipulate the images of the advertisements to conform to the software and hardware capabilities of the mobile device 202 such as mobile phone screen dimensions.

Consider an example, where the user 201 wishes to obtain a phone number or a map of a pizza store. On receiving the interactable advertisement of the pizza store on the client application 202a, the user 201 may click on the “Click To Call” button 301b or the “Click To Map” button 301c on the GUI 202b of the client application 202a. On click of the “Click To Call” button 301b or the “Click To Map” button 301c, the client application 202a sends the request for the phone number or a map respectively along with the mobile application identifier, the user identifier, the mobile device properties, the current location of the mobile device 202, and an advertisement identifier that maps to a specific advertisement banner and thus to a specific advertisement campaign to the contextual information delivery system 204. The advertisement server 205 of the contextual information delivery system 204 identifies the user 201 and retrieves the user information, user preferences, long term usage statistics, etc. by communicating with the user and service provider information database 208a. The advertisement server 205 further communicates with the location server 207 and obtains the location based information such as the zip code, the area code, and street address of the user 201 from the location database 207a.

The advertisement server 205 then queries the advertisement database 205c with the advertisement identifier provided in the sent request and retrieves a record for the advertisement campaign associated with the advertisement identifier. On retrieving the advertisement campaign information, the advertisement server 205 utilizes a combination of the location based information from the location database 207a and the queries to the advertisement database 205c to retrieve the context specific information requested by the client application 202a. The advertisement server 205 then sends a response comprising the requested phone number or map to the client application 202a. Further, the advertisement server 205 stores the accounting pertaining to the request.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A ‘processor’ means any one or more microprocessors, central processing unit (CPU) devices, computing devices, microcontrollers, digital signal processors or like devices. The term ‘computer-readable medium’ refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a compact disc-read only memory (CD-ROM), digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

Where databases are described such as the user and service provider information database 208a, the advertisement database 206c, the content database 206c, and the location database 207a, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the internet, local area network (LAN), wide area network (WAN) or Ethernet, Token Ring, or via any appropriate communications means or combination of communications means. Each of the devices may comprise computers, such as those based on the Intel® processors, AMD® processors, etc. that are adapted to communicate with the computer. Any number and type of machines may be in communication with the computer.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A method of providing context aware multimedia content and interactable advertisements of business services on visually distinct and mutually independent display sections on a screen of a mobile device, comprising the steps of:
providing a client application on said mobile device of a user;
sending a first request for said context aware multimedia content by said client application to a content server, wherein said multimedia content comprises at least one of text content, image content, audio content, and video content;
sending a second request for said context aware interactable advertisements by the client application to an advertisement server;
establishing context of said first request and said second request based on a plurality of contextual parameters;
selecting said multimedia content and said interactable advertisements based on said established context, wherein the interactable advertisements comprise dynamic user interface components for enabling said user to activate one or more of a plurality of access functions on the client application to access said business services; and
rendering said selected multimedia content and said selected interactable advertisements to the client application on said visually distinct and mutually independent display sections on said mobile device screen;
whereby the context aware multimedia content and the context aware interactable advertisements are provided on the visually distinct and mutually independent display sections on the mobile device screen.

2. The method of claim 1, wherein said display sections comprise a first display section for displaying said rendered multimedia content, a second display section for displaying said rendered interactable advertisements, and a third display section for displaying said dynamic user interface components of the interactable advertisements.

3. The method of claim 1, further comprising a step of obtaining user information from the user on a host website, wherein the user information comprises content preferences of the user, user profile, and software and hardware capabilities of the mobile device of the user.

4. The method of claim 1, further comprising a step of obtaining service provider information from a plurality of service providers of the business services on a host website, wherein said service provider information comprises advertisements, advertising preferences associated with said dynamic user interface components to be displayed on the client application, contact information, promotional coupons, sales coupons, multimedia download content, and driving directions to locations of the business services.

5. The method of claim 4, wherein said advertisements comprise advertisement banner images, coupon images, promotional audio downloads, promotional video downloads, phone numbers of the business services, addresses of the business services, and business service delivery constraints.

6. The method of claim 1, wherein said context of the first request is established by the content server and said context of the second request is established by the advertisement server.

7. The method of claim 1, wherein said step of establishing said context of the first request and the second request comprises a step of determining location of the mobile device based on global positioning system capabilities of the mobile device.

8. The method of claim 1, wherein said contextual parameters comprises one of location of the mobile device, date, time in said location, weather, events, traffic at the location, multimedia content previously rendered to the mobile device, user profile, preferences of the user, request patterns of the user, multimedia content and advertisement usage by the user over a predefined period of time, software and hardware capabilities of the mobile device, and any combination thereof.

9. The method of claim 1, wherein the selected multimedia content and the selected interactable advertisements are rendered independently to the client application based on predefined criteria, wherein said predefined criteria comprises time of expiry allotted for display of the multimedia content and the interactable advertisements, activities performed by the user on the client application, change in location of the mobile device, and change in schedule of events at said location.

10. The method of claim 1, wherein said access functions comprise calling the business services, sending one of voice messages and text messages to the business services, obtaining directions to locations of the business services, obtaining promotional coupons and sales coupons of the business services, downloading the multimedia content from business service websites, and accessing said business service websites.

11. The method of claim 10, wherein said directions to said locations of the business services are displayed on the client application as one of a text based direction, a static map, and a global positioning system direction map.

12. The method of claim 1, wherein one or more of said dynamic user interface components enable the user to navigate through a list of said access functions displayed as an advertisement menu on the client application.

13. A system for providing context aware multimedia content and interactable advertisements of business services on visually distinct and mutually independent display sections on a screen of a mobile device, comprising:
a client application provided on said mobile device of a user, comprising:
a graphical user interface for displaying said context aware multimedia content and interactable advertisements of said business services on said visually distinct and mutually independent display sections, wherein said display sections comprise a first display section and a second display section;
a request transfer module for sending a first request for said context aware multimedia content to a content server and a second request for said context aware interactable advertisements to an advertisement server;
said content server, comprising:
a content context establishment module for establishing context of said first request based on a plurality of contextual parameters;
a content selection module for selecting said multimedia content from a content database based on said established context of the first request;
a content delivery module for rendering said selected multimedia content to said client application on said first display section of said graphical user interface on said mobile device screen;
said advertisement server, comprising:
an advertisement context establishment module for establishing context of said second request based on said contextual parameters;
an advertisement selection module for selecting said interactable advertisements from an advertisement database based on said established context of the second request, wherein the interactable advertisements comprise dynamic user interface components for enabling said user to activate one or more of a plurality of access functions to access the business services; and
an advertisement delivery module for rendering said selected interactable advertisements to the client application on said second display section of the graphical user interface on the mobile device screen.

14. The system of claim 13, wherein said graphical user interface displays said dynamic user interface components on a third display section, wherein the dynamic user interface components enable the user to make phone calls to the business services, send one of voice messages and text messages to the business services, obtain directions to locations of the business services, obtain promotional coupons and sales coupons of the business services, download the multimedia content from business service websites, and access said business service websites.

15. The system of claim 13, wherein the client application further comprises a global positioning system module for transferring global positioning system coordinates of the mobile device of the user to a location server.

16. The system of claim 15, wherein said location server performs reverse geocoding of said transferred global positioning system coordinates from said global positioning system module to determine location of the mobile device.

17. The system of claim 16, wherein the location server comprises a location database for storing location based information, wherein said location based information comprises weather at said location, time in the location, traffic at the location, schedule of events at the location.

18. The system of claim 13, further comprising a web server, wherein said web server comprises a user and service provider information database for storing user information and service provider information.

19. The system of claim 18, wherein said user information comprises content preferences of the user, user profile, and software and hardware capabilities of the mobile device of the user, further wherein said service provider information comprises advertisements, advertising preferences associated with the dynamic user interface components to be displayed on the client application, contact information, promotional coupons, sales coupons, multimedia download content, and driving directions to locations of the business services of service providers.

20. The system of claim 13, wherein said advertisement database stores interactable advertisements comprising advertisement banner images, coupon images, promotional audio downloads, promotional video downloads, phone numbers of the business services, addresses of the business services, and business service delivery constraints.

21. The system of claim 13, wherein said content database stores the multimedia content comprising text content, image content, audio content, and video content.

22. The system of claim 13, wherein the content server further comprises a content timer module for determining duration of display for said rendered multimedia content to the client application.

23. The system of claim 13, wherein the advertisement server further comprises an advertisement timer module for determining duration of display for said rendered interactable advertisements to the client application.

24. A computer program product comprising computer executable instructions embodied in a computer-readable medium, wherein said computer program product comprises:
a first computer parsable program code for providing a client application on a mobile device of a user;
a second computer parsable program code for sending a first request for context aware multimedia content;
a third computer parsable program code for sending a second request for context aware interactable advertisements of business services;
a fourth computer parsable program code for establishing context of said first request and said second request based on a plurality of contextual parameters;
a fifth computer parsable program code for selecting said multimedia content and said interactable advertisements based on said established context;
a sixth computer parsable program code for rendering said selected multimedia content to said client application on a first display section on a screen of said mobile device;
a seventh computer parsable program code for rendering said selected interactable advertisements to the client application on a second display section on said mobile device screen; and
an eighth computer parsable program code for enabling said user to access said business services rendered as the interactable advertisements to the client application.
